(19) United States
(12) Patent Application Publication
(10) Pub. No.: US 2022/0268085 A1
(43) Pub. Date: Aug. 25, 2022

(54) METHOD FOR OPERATING A DOOR SYSTEM

(71) Applicant: dormakaba Deutschland GmbH, Ennepetal (DE)

(72) Inventors: Chandra GUPTA, Ennepetal (DE); Jelic SLOBODAN, Ennepetal (DE); Martin BOECKHOFF, Ennepetal (DE)

(21) Appl. No.: 17/668,085

(22) Filed: Feb. 9, 2022

(30) Foreign Application Priority Data
Feb. 12, 2021 (EP) 21156780.5

(51) Int. Cl. E05F 15/73

(52) U.S. Cl. CPC E05F 15/73; E05F 2015/767; E05Y 2400/44; E05Y 2900/132

(57) ABSTRACT

A method for operating a door system, with the door system having a door leaf and with a first sensor unit being configured on a first door side and a second sensor unit on an opposing second door side, and with the approach of a person being detected with the first sensor unit, with the method having at least the following steps: determining a probable approach time of the person after which the person passes through the door system after being first detected; opening the door leaf; storing the approach time; recording an exit time of the person from the second door side using the second sensor unit and holding open the door leaf for an opening period which is determined from the recorded exit time or the approach speed, depending on which time is longer. A door system having a control unit is configured to carry out this method.

### CROSS-REFERENCE TO RELATED APPLICATIONS

This application is related to and claims the benefit of European Patent Application No. 21156780.5, filed on Feb. 12, 2021, the contents of which are herein incorporated by reference in their entirety.

### TECHNICAL FIELD

The disclosure relates to a method for operating a door system, with the door system having a door leaf and with a first sensor unit being configured on a first door side and a second sensor unit on an opposing second door side, and with the approach of a person being detected with the first sensor unit. The disclosure also relates to a door system having a control unit which is designed to carry out the method according to the disclosure.

### BACKGROUND

Door drives are known, which are connected to sensor units designed to detect people, for controlling automatic door systems, in particular sliding doors and swing leaf doors.

Thus, for example DE 203 20 497 U1 shows a door system having a door drive and having a sensor unit, with the sensor unit serving as a presence sensor and with which the presence of people can be detected in a detection area. When the person is detected, the opening of the door leaf of the door system is triggered via the door drive. In this case, it is indicated that radar sensors can also be used as sensor units. Disadvantageously however, only a single opening signal is generally generated by the control unit as soon as the sensor unit has detected the presence of a person. In this case, a door leaf movement can be triggered, but this often occurs too early or too late or is otherwise unsuitable, for example if the door leaf is moved with an excessively small or large opening angle.

The optimum in the control of door systems is in particular to enable the door system to be passed as comfortably as possible by the people, in particular without the people having to significantly change their movement direction and movement speed. On the other hand, when optimizing the control of a door system, it must also, however, be ensured not to guide a door leaf out of the closure position for longer than is necessary, in particular on cold days. In this case, it must be ensured that energy losses are avoided which result from door leaves being open for an unnecessarily long time and opening the door too often, too quickly, too wide and for too long can also progress the wearing of a door drive and therefore wearing of the door system more quickly than is necessary.

These disadvantages often result from the functioning of sensors of the sensor units which are not always reliable. It may for example happen that a person approaching a door system must interrupt the advancing movement if the door leaf opens too late as the sensor unit has detected the person too late. If the person has passed the door system, the door leaf should be prevented from closing too early if there is a further malfunction of the second sensor unit.

The difficulty with controlling the correct opening and closing times of the door leaf results, among other things, from the fact that the immediate region before the door system is not always recorded when using radar sensors in sensor units. A distant area is differentiated from a near area in the region before the door system in a manner known per se, with people being detected with the sensor units substantially only in the distant area, with the person in the near area being detected with further sensors, for example ultrasound sensors or optical sensors, to primarily protect closure edges of the door system.

However, in general, the opening and closing times as well as the opening hold period of the door leaf is determined based on the detection information of the sensor units which cover the distant areas, in particular if it concerns radar sensors. If a person passes a door system, then said person also passes through a shadow region (subsequent areas) between two detection regions of the sensor units (distant areas), which are mounted on opposing sides of the door system.

If the person is not detected in good time on the rear side of the door with the second sensor unit in order to determine a probable exit time of the person, then this can lead to a premature closing movement of the door leaf and the door leaf for example turns into the movement path of the person.

### SUMMARY

The disclosure improves a method for operating a door system, which in particular allows the opening hold period and the closing time of the door leaf to be determined such that the door leaf does not negatively affect the walking movement of the person passing the door system, with the door leaf also not leaving its closure position for longer than is necessary.

This is achieved by providing a method according to the preamble of the claim 1 and also proceeding from a door system according to claim 13 each with the characterizing features. Advantageous further developments of the disclosure are each indicated in the dependent claims.

The method according to the disclosure comprises at least the following steps: determining a probable approach time of the person after which the person passes through the door system after being first detected; opening the door leaf; storing the approach time; recording an exit time of the person from the second door side by means of the second sensor unit and holding open the door leaf for an opening period which is determined from the recorded exit time or the approach speed, depending on which time is longer.

The core idea of the disclosure is the improved safety, to ensure an opening hold period of the door leaf even after the person passes through the door system, which lasts at least as long as the approach time of the person lasted. If the second sensor unit fails on the exit side of the door system, the door leaf remains open at least as long as the approach time such that it can be ensured that, for an assumed uniform movement of the person when passing the door system, the door leaf does not interrupt the person when they exit the door, the door leaf of a pivot leaf door in particular does not turn into the movement path of the person. If the approach time and the exit time are roughly the same, then the exit time can be used unchanged in the case of only a small deviation, for example ≤10% of the times between the approach time and the exit time. A comparison is made here preferably regularly, in particular for each entry.

According to an advantageous further configuration of the method, it is provided that the probable approach time is determined at least from an approach speed of the person moving towards the door system detected by the first sensor unit by means of a control unit and/or stored at least in a volatile manner. Long opening hold times of the door leaf often result from opening hold times being set for unnecessarily long times on the control unit. The sensor evaluation according to the disclosure allows the pre-set opening hold time to be disregarded and therefore makes this setting unnecessary.

It is further provided that the probable approach time is determined by means of the control unit at least from a distance of the person from the door leaf detected by the first sensor unit and an approach speed detected by the first sensor unit. In particular, the approach time is determined by the distance-time law by the distance being divided by the approach speed to obtain the approach time.

It is further advantageously provided that the first and/or second sensor unit has a radar sensor with which the approach speed and/or the distance of the person from the door leaf is recorded. Radar sensors enable not only the presence of a person to be detected, but can also determine the distance of the person, for example from the door system, and a radar sensor also allows an approach speed of a person to be determined. Furthermore, a radar sensor can detect whether a person moves towards the door system or whether the person moves away from the door system. Furthermore, a radar sensor can also record an approach angle at which a person approaches the door system. The detectable physical variables can be provided by the sensor unit during each entry to the door system for the entire entry time to the control unit of the door system in order to ultimately optimally control the movement of the door leaf. Therefore, one opening signal and, if applicable, one closing signal are no longer only emitted by means of the sensors, but rather a permanent provision of data by the sensor unit to the control unit takes place during the entire entry of at least one person to the door system.

In particular by designing at least one sensor of the first and/or second sensor unit as a radar sensor, further-reaching possibilities are opened up to improve the method for operating a door system according to the disclosure. The core idea of the disclosure is here to detect the person not only in terms of their mere presence, but in particular to also record the approach speed, the distance of the person from the door system and the approach angle and provide them over the entire entry period.

According to a further aspect of the method according to the disclosure, the approach time is stored at least in a volatile manner in the control unit of the door system in a memory. In particular, the actual passage time of the person is recorded and/or calculated and/or the passage time forms the basis of the approach time stored in the memory.

The passage time of the person can in this respect be determined for each entry discretely via the approach time by means of the distance-time law based on the distance and the approach speed of the person. However, it is also conceivable that a currently determined approach time is combined with approach times stored in the memory. In this way, the determination of the actual passage time of the person can be continuously optimized.

In particular, in the case of at least one volatile storage of entry data, empirical values can be used when the control unit makes use of the stored data in the memory when, for example, approach times are determined with an average in order to determine the passage time from the data in the memory. The passage time can in particular also be determined by an average time being calculated between exiting the distant area before the door system and detecting the person behind the door system. According to the disclosure, the passage time is half the value of the duration that the person is located in the sensor shadow, i.e. the time between exiting the distant area on the entry side and the re-detection of the person on the exit side. However, it is also conceivable that the passage time is determined with other sensors which, in addition to the radar sensors, can also be part of the sensor units or are attached to the door system as separate sensors, for example ultrasound sensors and/or optical sensors, which are preferably used for protecting closure edges.

It can also be provided that the approach time of each person passing the door system is cumulatively and/or discretely stored such that the prediction of the approach time is continuously optimized based on the recording of the approach speed and/or the distance of the person from the door leaf. In this case, it is conceivable that the stored approach times are also deleted again after a predeterminable time. It is in particular advantageous when a roughly constant number of discretely stored approach times is stored in the memory of the control unit, particularly advantageously also in conjunction with the actually identified passage time in order to continue the continuous optimization.

Moreover, according to the method, an approach angle can be determined with the first sensor unit at which the person approaches the door system and/or it is provided that an exit angle is determined with the second sensor unit.

Additionally, it can be provided that the approach time is determined taking into account the approach angle such that the time of the opening of the door leaf is carried out depending on the approach angle. Taking the approach angle into account can be combined here with the evaluation of the approach speed and the distance of the person.

In particular, the control unit has a comparison module with which the recorded exit time and the approach time are compared with one another. In this case, a tolerance range can be provided within which the exit time essentially forms the basis for determining the closing time of the door leaf. However, if the difference between the exit time and the approach time exceeds a tolerance value, for example 10%, then, according to the disclosure, the approach time also forms the basis of the determination of the opening hold period of the door leaf after the comparison, by it being assumed that the person requires the same time to exit the door as the time required to approach the door, in relation to a distance that is the same before the door and behind the door.

The method according to the disclosure can in particular also be defined in that the region before the door system is divided into a distant area and a near area, with people being detected substantially in the distant area by the first and second sensor unit and/or with the near area being covered with other sensors.

In particular, the determined approach time can be added to a list of approach times in the control unit, with the determination of the probable exit time relating to the previously determined approach time and/or being based on the list of stored approach times. In particular, both the currently determined approach time and the list of the stored approach times can also be considered equally such that when an average value of an approach time is determined, empirical values can also be factored in.

In particular, a door system is being protected with which the method according to the disclosure, in particular the method according to one of claims 1 to 12, can be carried out.

The disclosure is also aimed at a computer program product for implementation in a control unit of a door system having the previously described features, which is designed to carry out the method according to the disclosure in accordance with the above description.

The door system is in particular designed as an automatic sliding door system, as a swing leaf door system or as a folding leaf door system and these systems can have a control unit, with which the method according to the disclosure can be carried out.

Features and details, which are described in connection with the method according to the disclosure, also apply here in connection with the door system according to the disclosure and vice versa. In this case, the features listed in the description and in the claims may each be essential to the disclosure individually by themselves or in combination. A computer program product is also being protected which can be implemented in the control unit, with the features and advantages, which are listed above in connection with the method according to the disclosure, also being applicable to the computer program product.

### BRIEF DESCRIPTION OF THE DRAWINGS

Further measures that improve the disclosure will be outlined in greater detail below together with the description of a preferred exemplary embodiment of the disclosure on the basis of the figures, in which are shown:

FIG. 1 a view of a door system with people shown on a first door side and on a second door side, with the people moving from left to right through the door system,

FIG. 2 a plan view of a door system with a person who approaches the door system at an approach angle,

FIG. 3 a method sequence for operating a door system without the method carried out according to the disclosure, and

FIG. 4 a method for operating a door system with the method carried out according to the disclosure.

### DETAILED DESCRIPTION OF THE DRAWINGS

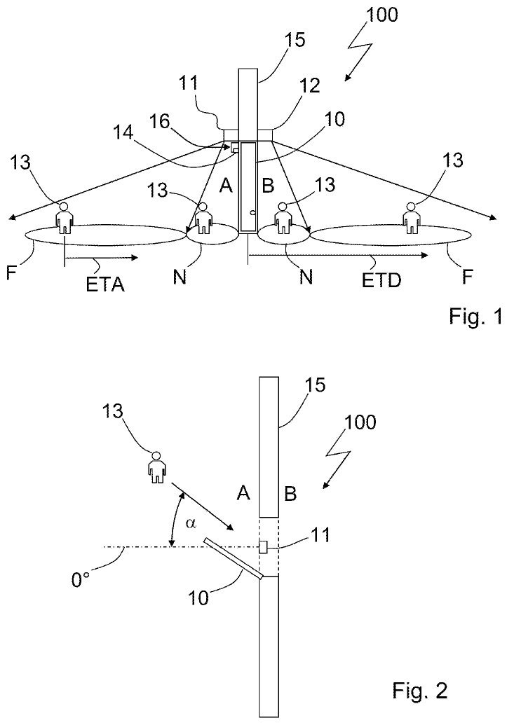

FIG. 1 shows, in a side view, a door system 100 having a door leaf 10, which is arranged in a wall 15 so as to be rotatable. To actuate the door leaf 10, a door drive 16 is used, which has a control unit 14, and the control unit 14 does not have to be a structural component of the door drive 16, and the control unit 14 can also be arranged separately. The door drive 16 can open and close the door leaf 10, with the door leaf 10 being represented closed in the arrangement shown.

On a first door side A, a first sensor unit 11 is used to monitor a first distant area F and on the second door side B, a second sensor unit 12 is used to monitor a second distant area F. The near areas N adjoining the door system 100 can, but must not necessarily, be monitored by the sensor units 11, 12 which are preferably designed as radar sensors. The near areas N can be monitored by optical sensors or by ultrasound sensors, in particular incorporating closure edge monitoring.

In the image shown, a person 13 is drawn in multiple times, who moves towards the door system 100 from left to right on the first door side A and the person 13 shown moves away from the door system 100 on the second door side B.

If the person 13 now moves towards the door system 100 on the first door side A, then the first sensor unit 11 designed as a radar sensor detects the person 13 and a probable approach time ETA is determined from the distance and the approach speed of the person relative to the door system 100. The probable approach time ETA is the time which the person 13 requires, from the position shown, to cross the door system 100 and the probable approach time ETA is calculated with the control unit 14.

The person 13 shown on the second door side B is detected by the second sensor unit 12 and an exit time ETD is determined with the recording of the distance of the person 13 and the exit speed from the door system 100.

The method according to the disclosure is carried out with at least the following steps: determining a probable approach time ETA of the person 13 after which the person 13 passes through the door system 100 after being first detected; opening the door leaf 10; storing the approach time ETA; recording an exit time ETD of the person 13 from the second door side B by means of the second sensor unit 12 and holding open the door leaf 10 for an opening period which is determined from the recorded exit time ETD or the approach speed ETA, depending on which time is longer.

The comparison of the exit time ETD with the approach time ETA takes place in the control unit 14, which, for this purpose, has a comparison module to compare the times.

FIG. 2 shows a plan view of a door system 100 which is arranged in the opening of a wall 15. The door system 100 has a pivotable door leaf 10 in a manner known per se which is shown in an open position. A first sensor unit 11 is located above the passage region through the wall 15 and the first sensor 11 monitors the first door side A. For the sake of simplicity, a second sensor unit on the second door side B is not shown, but it is present.

The person 13 approaches the door system 100 according to this example not from the orthogonal direction drawn in, but rather at an approach angle α. The approach angle α is also monitored by the first sensor unit 11 and the approach time ETA can also be determined here taking into account the approach angle α.

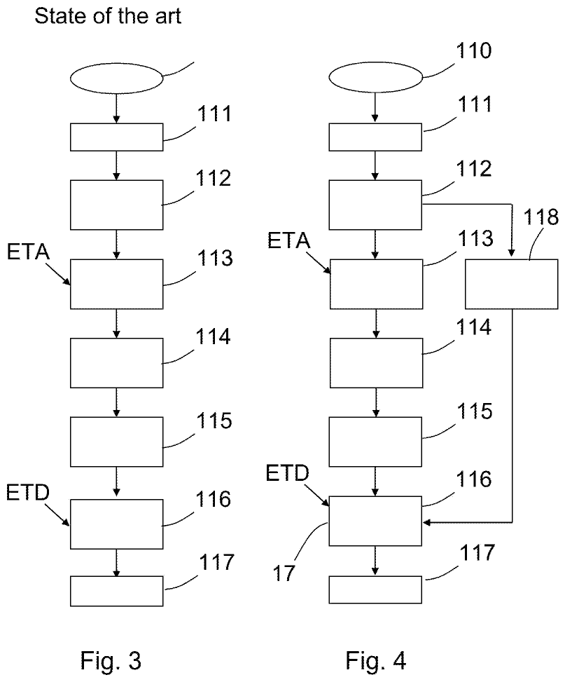

FIG. 3 and FIG. 4 each show a schematic sequence of the method steps, with FIG. 3 reflecting the state of the art and FIG. 4 has, superimposed on the view of the state of the art, the features of the disclosure about which detail will be given later.

The method step 110 in FIGS. 3 and 4 designates the detected status of the door system as being closed. The detected status “closed” 110 precedes the method according to the disclosure as the first method step.

A second method step 111 follows the approach of the person which is detected by the first sensor unit. This is followed by the method step 112 or the determination of the approach time ETA and the determined approach time ETA is used in the method step 113 for the opening algorithm.

Then, the person passes the door system 100 according to method step 114 and in method step 115, the second sensor unit is used to measure the distance and the exit speed. In step 116, the exit time ETD is determined from the values of step 115 in order to provide a closing criterion to close the door leaf. Lastly, in method step 117, the close command is emitted to close the door leaf.

According to FIG. 4, the further method step 118 is indicated which relates to the immediate storage and provision of the approach time ETA, which follows from step 112. The value of the approach time ETA is then reused in method step 116 with the exit time ETD being determined. To this end, the comparison module 17 is provided in the control unit with which the approach time ETA and the exit time ETD are compared. Depending on which time is longer, i.e. which causes the door leaf 10 to close later, the method step 117 will be carried out to close the door leaf after the later time.

The design of the disclosure is not restricted to the preferred exemplary embodiment indicated above. In fact, a number of variants is conceivable which make use of the solution represented even in the case of essentially different embodiments. All features and/or advantages emerging from the claims, the description or the drawings, including constructive details or spatial arrangements, may be essential to the disclosure by themselves and in the most varied combinations.

1. A method for operating a door system, wherein the door system has a door leaf and wherein a first sensor unit is configured on a first door side and a second sensor unit on an opposing second door side, and wherein the approach of a person is detected with the first sensor unit, with the method having at least the following steps:
determining a probable approach time of the person after which the person passes through the door system after being first detected,
opening the door leaf,
storing the approach time,
recording an exit time of the person from the second door side by the second sensor unit, and
holding open the door leaf for an opening period determined from the recorded exit time or the approach speed, depending on which time is longer.

2. The method according to claim 1,
wherein
the probable approach time is determined fusing a control unit at least from an approach speed of the person moving towards the door system detected by the first sensor unit and/or stored at least in a volatile manner.

3. The method according to claim 2,
wherein
the probable approach time is determined using the control unit at least from a distance of the person from the door leaf detected by the first sensor unit and an approach speed detected by the first sensor unit.

4. The method according to claim 1,
wherein
the first and/or second sensor unit has a radar sensor, with which the approach speed and/or the distance of the person from the door leaf is recorded.

5. The method according to claim 2, wherein
the approach time is stored at least in a volatile manner in the control unit of the door system in a memory and/or wherein the actual passage time of the person is recorded and/or calculated and/or the passage time forms the basis of the approach time stored in the memory.

6. The method according to claim 1, wherein
the approach time of each person passing the door system is cumulatively and/or discretely stored such that the prediction of the approach time is continuously optimized based on the recording of the approach speed and/or the distance of the person from the door leaf.

7. The method according to claim 1,
wherein
an approach angle is determined with the first sensor unit at which the person approaches the door system and/or in that an exit angle is determined with the second sensor unit.

8. The method according to claim 1,
wherein
the approach time is determined by taking into account the approach angle wherein the time of the opening of the door leaf is carried out depending on the approach angle.

9. The method according to claim 2, wherein
the prediction of the approach time is continuously optimized based on the recording of the approach speed and/or the distance of the person from the door leaf based on data stored in the memory of the control unit.

10. The method according to claim 2, wherein
the control unit has a comparison module with which the recorded exit time and the approach time are compared with one another.

11. The method according to claim 1, wherein
the region before the door system is divided into a distant area and a near area, wherein people are detected substantially in the distant area by the first and second sensor unit and/or wherein the near area is covered with other sensors.

12. The method according to claim 2, wherein
the determined approach time is added to a list of approach times in the control unit, wherein the determination of the probable exit time relates to the previously determined approach time and/or is based on the list of stored approach times.

13. A door system having a control unit designed to carry out a method according to claim 1.

14. The door system according to claim 13,
wherein
the door system is configured as an automatic sliding door system, as a swing leaf door system or as a folding leaf door system.

15. A computer program product for implementation in a control unit of a door system configured to carry out a method according to claim 1.
